(19) United States
(12) Patent Application Publication
(10) Pub. No.: US 2018/0293819 A1
(43) Pub. Date: Oct. 11, 2018

(54) METHODS AND SYSTEMS TO NOTIFY REDUCTANT REFILL IN A VEHICLE

(71) Applicant: Ford Global Technologies LLC, Dearborn, MI (US)

(72) Inventor: David Ross, Newport (AU)

(21) Appl. No.: 15/904,099

(22) Filed: Feb. 23, 2018

(30) Foreign Application Priority Data
Apr. 7, 2017 (CN) 201710227582.0

(51) Int. Cl. G07C 5/08

(52) U.S. Cl. CPC G07C 5/0825; F01N 3/2066

(57) ABSTRACT

A method to notify a user of the requirement to refill a reductant tank in a vehicle is provided. The method comprises monitoring a reductant level in a reductant tank and a reductant consumption rate; monitoring a fuel level in a fuel tank and a fuel consumption rate; determining a state of the reductant in the reductant tank based on one of the reductant level, the reductant consumption rate, the fuel level and the fuel consumption rate; and displaying the state of the reductant in the reductant tank on a reductant refill indicator located at a place adjacent to a fuel filler door.

### RELATED APPLICATION

This application claims the benefit of Chinese Patent Application No.: CN 201710227582.0 filed on Apr. 7, 2017, the entire contents thereof being incorporated herein by reference.

### FIELD

The present disclosure relates generally to methods and systems to notify reductant refill in a vehicle, in particular, relates to methods and systems to notify a user of the requirement to refill a reductant tank with an indicator located at a place adjacent to a fuel filler door.

### BACKGROUND

Emissions regulations are driving more vehicle manufacturers to utilize SCR (selective catalytic reduction) technology where a reductant such as urea is added to an exhaust flow and reacts over a catalyst in order to reduce tailpipe NOx emissions. In some jurisdictions, legislation contains detailed descriptions on how the “urea warning system” shall operate on vehicles which utilize urea systems. The urea warning systems have been used in a vehicle. However, it is not easy for the customers to understand and use. Often the customers may not know their vehicles have a urea system until they get a warning on the instrument cluster distracting them when they are driving. The inventor has recognized that there is need to provide a system or a method for intuitive display of a reductant level in a reductant tank to the customers to alert them the need to reductant refill while avoid distraction to the activities such as driving a vehicle or starting a vehicle.

### SUMMARY

According to one aspect, a method is provided to notify a user of the requirement to refill a reductant tank. The method comprises monitoring a reductant level in a reductant tank and a reductant consumption rate; monitoring a fuel level in a fuel tank and a fuel consumption rate; determining a state of the reductant in the reductant tank based on one of the reductant level, the reductant consumption rate, the fuel level and the fuel consumption rate; and displaying the state of the reductant in the reductant tank on a reductant refill indicator located at a place adjacent to a fuel filler door.

In one embodiment, determining the state of reductant includes determining a number of fuel tank refills before a reductant in the reductant tank is depleted.

In another embodiment, the method may further comprise estimating an average fuel level remained in the fuel tank when a user refuels the fuel tank based on a fuel refueling profile of the user and the number of fuel tank refills before the reductant in the reductant tank is depleted is further determined taking into account of the average fuel level remained in the fuel tank.

In another embodiment, the method may further comprise monitoring a vehicle load condition and maintaining a vehicle usage profile. The number of fuel tank refills before the reductant in the reductant tank is depleted may be determined by further incorporating a safe factor.

In another embodiment, a higher safe factor is used in determining the number of fuel tank refills before the reductant in the reductant tank is depleted when the vehicle is operated under a high load condition for a predetermined period.

In another embodiment, the reductant refill indicator includes a label showing the number of fuel tank refills before the reductant in the reductant tank is depleted and a light source that illuminate a specific color corresponding to the number of tank refill before the reductant in the reductant tank is depleted.

In another embodiment, the reductant refill indicator includes a plurality of LED including green, yellow and red LEDs, and the red LED illuminates when the reductant refill is required after one fuel tank refill, and the red LED flashes when the reductant refill is required after less than one fuel tank refill.

In another embodiment, the method may further comprise sending an alert when the number of fuel tank refill before the reductant in the reductant tank is depleted is less than a predetermined number, and the reductant refill indicator is disposed on a back side of a fuel filler door or on a vehicle body adjacent to a fuel filler cap and inside the fuel filler door.

According to another aspect, a method is provided to notify a user of the requirement to refill a reductant tank in a vehicle. The method comprises determining a number of fuel tank refills before a reductant in a reductant tank is depleted based on information on a reductant level in a reductant tank, a fuel level in a fuel tank, a reductant consumption rate and a fuel consumption rate; and displaying information in a reductant refill indicator disposed on or adjacent to a fuel filler door to notify the number of fuel tank refill before the reductant is depleted.

In one embodiment, the reductant refill indicator may include at least one light source and a label, and illumination of the light source corresponds to a number of fuel tank refills before the reductant is depleted.

In another embodiment, the reductant level and the fuel level may be real time values detected by a reductant level sensor and a fuel level sensor, and the reductant consumption rate and the fuel consumption rate may be real time values obtained from a power train control module or an engine control module of the vehicle.

In another embodiment, the reductant level and the fuel level may be real time values determined by a reductant level sensor and a fuel level sensor, and the reductant consumption rate and the fuel consumption rate may be average values over a time period.

In another embodiment, a safe factor may be used in determining the number of fuel tank refills before the reductant in the reductant tank is depleted and the safe factor may be determined based on a vehicle load condition.

In another embodiment, the method further comprises sending an alert to an alert device at the reductant refill indicator when the number of fuel refills is below a predetermined value.

According to yet another embodiment, a reductant refill notification system in a vehicle is provided. The system comprises a reductant refill module to determine a state of reductant in a reductant tank; and a reductant refill indicator provided on or adjacent to a fuel filler door and configured to display the state of reductant according to instructions from the reductant refill module.

In one embodiment, the state of reductant in the reductant tank may be a number of fuel tank refills before a reductant in the reductant tank is depleted.

In another embodiment, the reductant refill module may be configured to communicate with a powertrain control module via CAN bus to obtain information on one of a fuel level in a fuel tank, a fuel consumption rate, a reductant level in a reductant tank, and a reductant consumption rate, a fuel refill profile of a user, and a profile of historical reductant consumption, and to determine the number of fuel tank refills before the reductant is depleted.

In another embodiment, the reductant refill indicator may include a label showing the number of fuel tank refills and a light source that illuminate a specific color corresponding to the number of tank refill.

In another embodiment, the reductant refill indicator may include a digit display to present the number of the fuel tank refills before the reductant in the reductant tank is depleted and an alert device to issue an alert when the of the fuel tank refills before the reductant in the reductant tank is depleted is less than a predetermined number.

In another embodiment, the state of the reductant level in the reductant may be an amount of the reductant in the reductant tank and the alert device may issue an alert when the amount of the reductant in the reductant tank is below a threshold.

The methods and systems to notify the reductant refill in a vehicle of the present disclosure inform a user of the status of the reductant level in the reductant tank each time he or she refuels the fuel tank. Because some fuel stations do not supply the reductant, the information provided enables the user to plan the reductant refill in advance. Further, the reductant refill indicator is located adjacent to a fuel filler door, the user' other activities such as starting the vehicle and the driving the vehicle are not affected.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a block diagram of an example vehicle system, in which a reductant notification system according to one embodiment of the present disclosure may be implemented.

FIG. 2 is a block diagram of another example vehicle system in which a reductant refill notification system according to one embodiment of the present disclosure may be implemented.

FIG. 3 is a flowchart of a method to notify a user of the requirement to refill a reductant tank according to one embodiment of the present disclosure.

FIG. 4A is a schematic view of a reductant refill indicator according to one embodiment of the present disclosure.

FIG. 4B is a schematic view of a reductant refill indicator according to another embodiment of the present disclosure.

FIG. 4C is a schematic view of a reductant refill indicator according to another embodiment of the present disclosure.

FIG. 4D is a schematic view of a reductant refill indicator according to another embodiment of the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed systems and methods to notify a user of the requirement to refill a reductant tank in a vehicle will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of systems and methods to notify a user of the requirement to refill a reductant tank in a vehicle are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

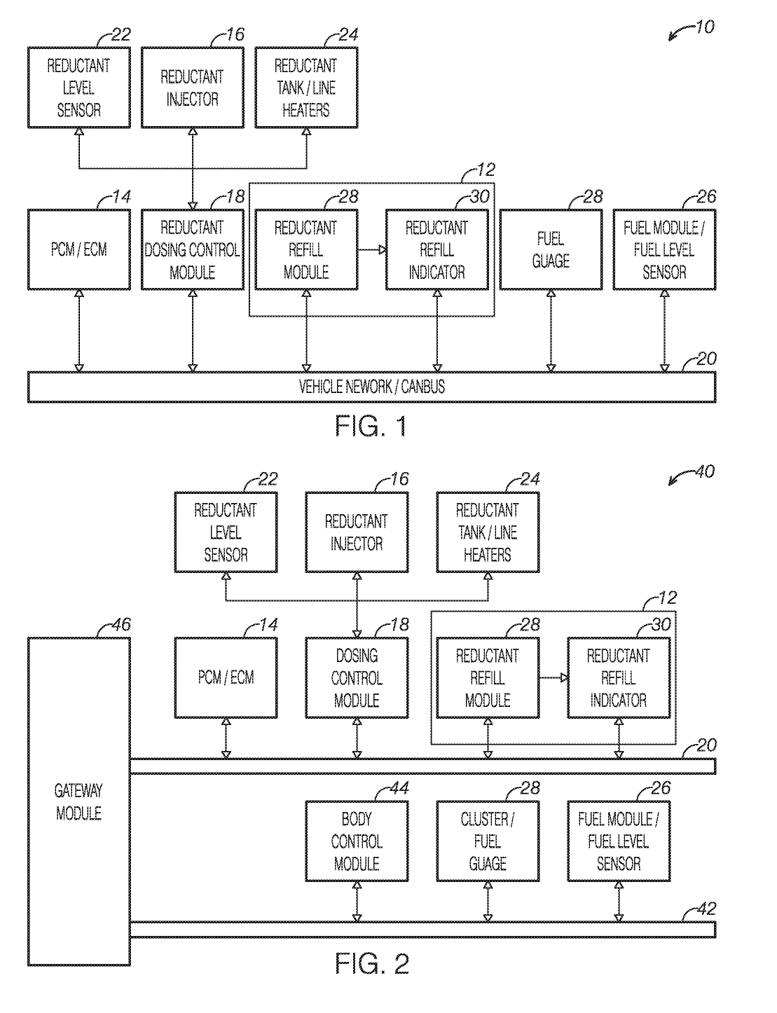

FIG. 1 is a block diagram of an example vehicle system 10 in which an example embodiment of a reductant refill notification system 12 of the present disclosure may be implemented and illustrates the communications between the system 12 and some electronic devices of a vehicle. The vehicle system 10 may include a power rain control module/an engine control module 14 conventionally used in the art. The engine control module may be a part of the power train control module. For example, the engine control unit 14 may control a series of actuators on an internal combustion engine to ensure optimal engine performance. The actuators may be adjusted by reading values from a multitude of sensors within the engine bay and interpreting the data using multidimensional performance maps.

A powertrain of a vehicle may include an exhaust gas treatment system including an exhaust gas treatment device. In some embodiments, the exhaust gas treatment system may be a selective catalyst reduction (SCR) system. In other embodiments, the exhaust gas treatment system may additionally or alternatively include a three-way catalyst (TWC), a NOx trap, various other emission control devices or combinations thereof. A reductant injector 16 may be disposed upstream of the exhaust gas treatment device and inject a reductant into the exhaust stream for reaction with NOx in the exhaust gas treatment device responsive to signals received from a PCM/ECU 14. The reductant injector 16 is supplied with the reductant from a reductant tank. The reductant may be urea or ammonia. The reductant injector 16 is communicated with a reductant dosing control module 18 which is communicated with the PCM/ECM via a bus 20.

The reductant consumption rate is needed for the operation of the exhaust gas treatment, notify that a reductant refill is needed, or other operational purpose, which may be determined according to a change of an amount of the reductant over time. The amount of the reductant in the reductant tank may be determined by a reductant level sensor 22. In some embodiments, the reductant level sensor 22 may be a float sensor which floats on the surface of the reductant. The PCM/ECM 14 may determine the volume of reductant in the reductant tank based on the position of the sensor. It should be appreciated that an indication of the reductant level may be based on a determination via measurement, calculation or combination thereof. In some embodiments, the reductant level sensor may be a magnetostrictive level sensor, an ultrasonic sensor, or a resistive chain level sensor.

The reductant dosing control module 18 may control the injection from the reductant injector 16 and the reductant supply from the reductant tank 24 based on information from PCM/ECM 14. In some embodiments, line heaters may be included in the exhaust gas treatment system to provide optimum temperature of the reductant for reaction in the SCR and other emission control devices.

The vehicle system 10 may further include a fuel system 26 including a fuel module and a fuel level sensor. Fuel gauge 28 is used to display the status of fuel in a fuel tank and is located in front of a driver at a cluster of an instrument panel. The vehicle may be powered by liquid fuel such as gasoline and diesel and the fuel gauge 28 may indicate a level of gasoline or diesel in the fuel tank.

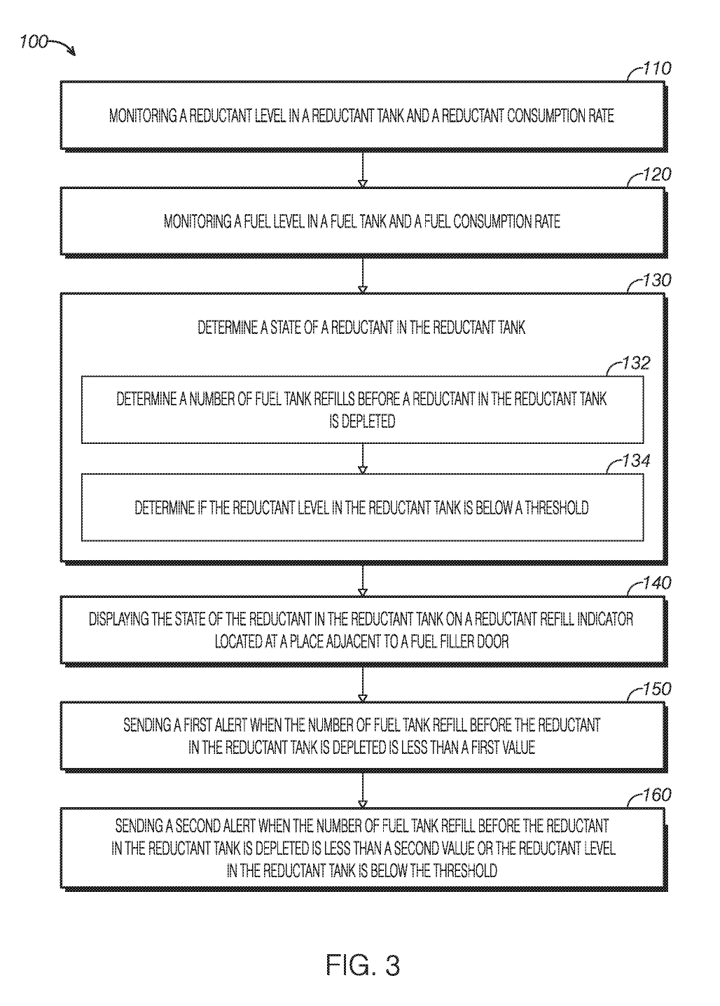

The vehicle may further include a reductant refill notification system 12 including a reductant refill module 28 and a reductant refill indicator 30. The reductant refill module 28 may be configured to determine the state of reductant in a reductant tank and instruct the reductant refill indicator to display the state of the reductant level. In some embodiments, the reductant refill indicator may be located at a place adjacent to a fuel filler door. The reductant refill module 28 may include a microprocessor unit, input/output ports, an electronic storage medium for executable programs and calibration values (e.g., a read only memory chip), random access memory, keep alive memory. Storage medium read-only memory may be programmed with computer readable data representing instructions executable by the microprocessor for performing the methods described below as well as other variants that are anticipated but not specifically listed. For example, the reductant refill module 28 may receive communication (e.g., input data) from the various sensors, the can bus of the vehicle, process the input data and trigger the actuators in response to the processed input data based on instruction or code programmed therein corresponding to one or more routines or methods. An example method is described herein with referent reference to FIG. 3. In the embodiment shown in FIG. 1, the reductant refill module 28 may be communicated with Can bus 20 of the vehicle system to obtain various input, process the input and send the instructions to reductant refill indicator 30 for display of the state of the reductant. For example, the reductant refill module 28 may obtain information on the reductant level, the reductant consumption rate, the fuel level and the fuel consumption rate from the Can bus 20.

In some embodiments, the state of reductant in the reductant tank is a number of fuel tank refills before the reductant in the reductant tank is depleted. The number of fuel tank refills before the reductant in the reductant tank is depleted may be determined based on the reductant level, the reductant consumption rate, the fuel level and the fuel consumption rate. The reductant consumption rate and the fuel level consumption rate may be calculated according to the change of the reductant level and the fuel level with the time, respectively. In one example, a ratio of the fuel consumption with respect to the reductant consumption can be calculated and thus the amount of the fuel to be filled before the reductant in the reductant tank is depleted can be calculated accordingly. By knowing the amount of the fuel to be filled for one reductant tank, the fuel remained in the fuel tank and the volume of the fuel tank, the number of fuel tank refills before the reductant in the reductant tank is depleted can be determined or estimated.

The estimation may further include calculating an average fuel level remained in the fuel tank when a user refills the fuel tank. For example, an algorithm in the reductant refill module 28 may estimate the average fuel amount remained in the fuel tank based on the user's refueling history. In one example, a routine may record the fuel remaining in the fuel tank when the user refills and an average fuel level remained in the last several occasions may be used in algorithm for estimation. The reductant refill module 28 may maintain a fuel refueling profile of the user so that the average fuel level remained in the fuel tank may be taken into account in determination of the number of fuel tank refills before a reductant in the reductant tank is depleted.

The reductant consumption may change with a vehicle load condition or a vehicle usage. In some conditions such as a high load condition when towing a trailer, the reductant consumption may change by factor of 3. When an average urea consumption is used for estimation the number of fuel tank refills before a reductant in the reductant tank is depleted, a safe factor may be used, which takes into account of the vehicle usage. For example, the reductant refill module 28 may include logic to detect whether the vehicle has operated at the high load conditions and a higher safe factor may be used in the estimation when the high load conditions are detected. Such algorithm may be particularly useful for commercial vehicles which are more likely to be towing or operation at maximum gross vehicle weight.

In some embodiments, the reductant level and the fuel level may be real time values detected by the reductant level sensor 22 and the fuel level sensor, 26. The reductant consumption rate and the fuel consumption rate may be real time values obtained from the PCM/ECM 14. It should be appreciated that any appropriate approaches may be used to determine the number of the fuel tank refill before the reductant is depleted. Upon the determination, the reductant refill module 28 may send instructions to the reductant refill indicator 30 for displaying the information.

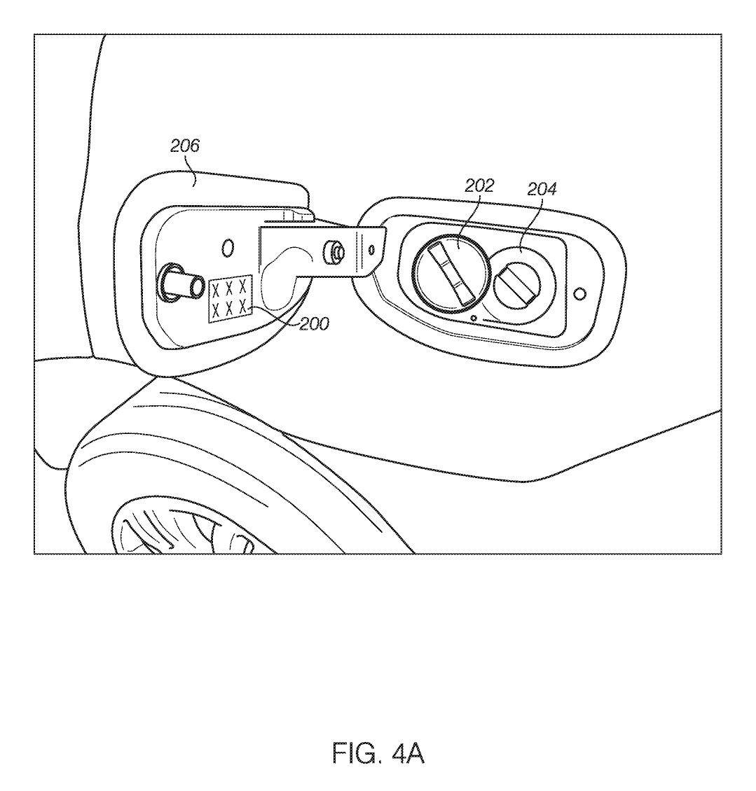

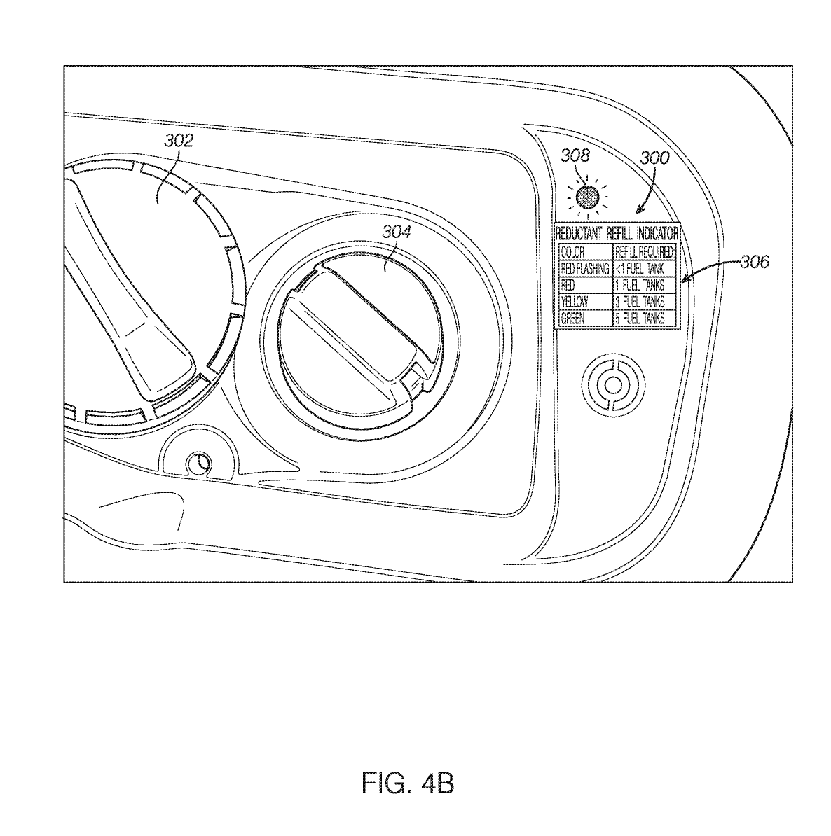

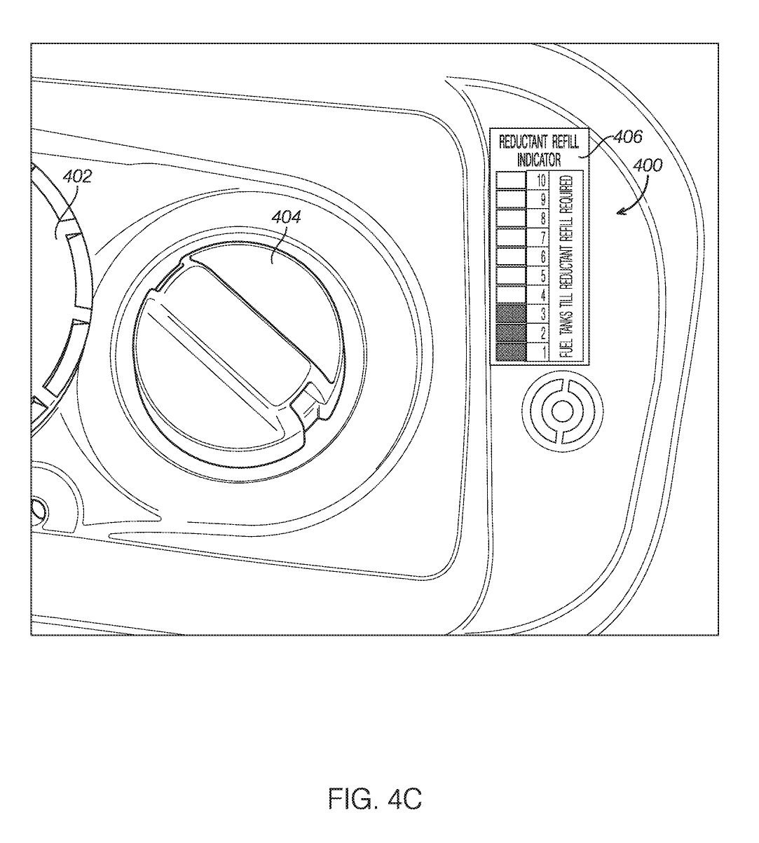

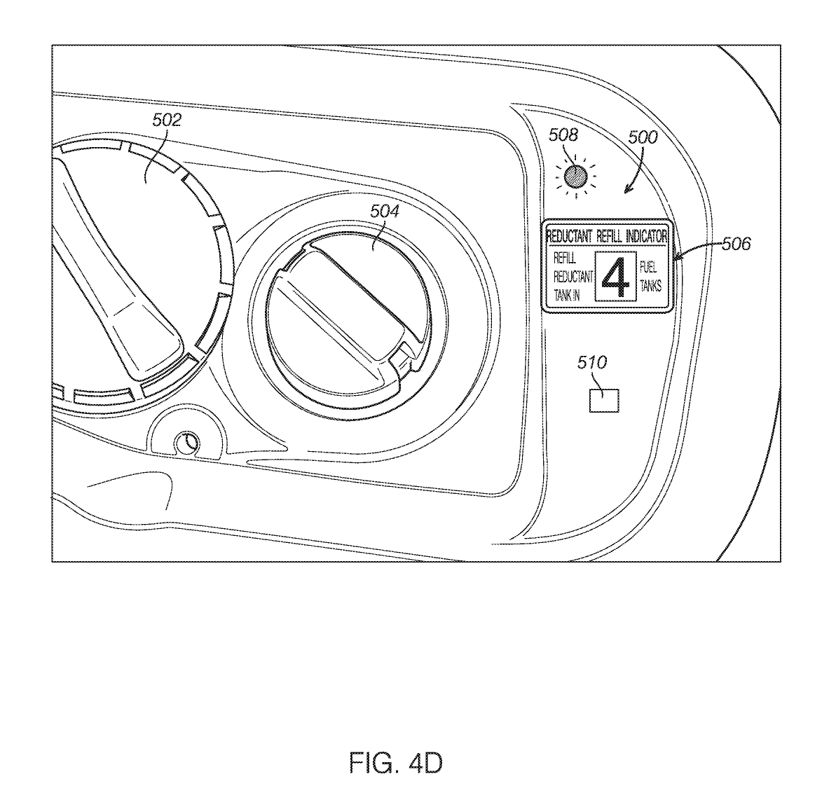

The reductant refill indicator 30 may be disposed at a location near a fuel filler door as described in detail associated with FIGS. 4A-4B. In some embodiments, the state of the reductant level in the reductant is an amount of the reductant in the reductant tank. The reductant refill indicator 30 may further include an alert device to warn the user to refill the reductant tank when the amount of the reductant in the reductant tank is below a threshold. As the user refuels the fuel tank, he or she will be notified the need to refill the reductant tank when the reductant amount is below a threshold. In some embodiments, the state of reductant in the reductant tank is a number of fuel tank refills before the reductant in the reductant tank is depleted. The user will be informed of the state of the reductant in the reductant tank every time he or she refuel the fuel tank and is alerted to take action depending on the state of the reductant in the reductant tank. In this way, the information on the reductant refill is presented when the user is not driving and/or when an action is required to taken based on the information presented.

It should be appreciated that the vehicle system 10 may further include other control units such as vehicle stability control unit, traction control unit and climate control unit (not shown in FIG. 1).

FIG. 2 is a block diagram of an example vehicle system 40, in which a reductant notification system according to one embodiment of the present disclosure may be implemented. The descriptions to the same elements as in the embodiments illustrated in FIG. 1 will be omitted or mentioned briefly for the sake of brevity. In other words, differences between the present embodiment and the embodiment of FIG. 1 will be mainly described. The vehicle system 40 has a plurality of CAN BUS 20, 42. The reductant refill notification system 12 is located in the CAN bus 20 to obtain most information from on engine operation from the PCM/ECM 14 and information on the reductant level and consumption from the reductant level sensor 16 and other information. Fuel module/fuel level sensor 26, fuel gauge 28 and a body control module 44 are located in the Can bus 42. The information from fuel module/fuel level sensor 26, fuel gauge 28 and the body control module 44 is taken by a gateway module 46 and retransmitted to the bus 20 so that the reductant refill notification system 12 can obtain the required information.

FIG. 3 is a flowchart of a method 100 to notify a user of the requirement to refill a reductant tank in a vehicle according to one embodiment of the present disclosure. At 110, the method 100 includes monitoring a reductant level in a reductant tank and a reductant consumption rate. The reductant level indicates an amount of the reductant left in the reductant tank and may be measured in real time by any suitable reductant level sensors as described above. The reductant consumption rate may be calculated according to the change of the reductant level over time and may calculated as a real time value or may be average value over a time interval. The reductant refill module as described above may perform the calculation or obtain the information from the powertrain control module or the engine control module.

At 120, the method 100 includes monitoring a fuel level in a fuel tank and a fuel consumption rate. The fuel level indicates an amount of the fuel left the fuel tank and may be measured in real time by any suitable fuel sensors. The fuel consumption rate may be calculated according to the change of the fuel level over time and may calculated as a real time value or may be average value over a time interval. The reductant refill module as described above may obtain the information from the powertrain control module or the engine control module.

At 130, the method 100 includes determining a state of the reductant in the reductant tank. In some embodiments, the state of the reductant in the reductant tank is a number of fuel tank refills before the reductant in the reductant tank is depleted. The method 100 may include determining a number of fuel tank refills before the reductant in the reductant tank is depleted at 132. The number of fuel tank refills before the reductant in the reductant tank is depleted may be determined using the approaches described above in associated with FIG. 1 or any suitable approaches. In this way, the reductant refill may correlate with the fuel refueling.

In some embodiments, the state of the reductant in the reductant tank is an amount of the reductant in the reductant tank. The method 100 includes determining whether the reductant left in the reductant tank is below a threshold at 134. The threshold may be an amount of the reductant that is sufficient for the exhaust gas treatment operation for a specific driving distance. The specific driving distance may be a range that a driver may find a reductant refill station.

At 140, the method 100 includes displaying the state of the reductant in the reductant tank on a reductant refill indicator located at a place adjacent to a fuel filler door.

At 150, the method 100 includes sending a first alert when the number of fuel tank refill before the reductant in the reductant tank is depleted is less than a first value. The reductant refill indicator may include an alert device to alert the need to refill the reductant. In some embodiments, the alert device may include a light source that illuminates a specific color corresponding to the number of tank refill.

At 160, the method 100 includes sending a second alert when the number of fuel tank refill before the reductant in the reductant tank is depleted is less than a second value less than the first value. The second alert is different from the first alert and provides a warning that further attracts the user's attention. For example, the first alert may be a display of a yellow light while the second alert may be a display of red light or a flash red light in the reductant refill indicator. Additionally or alternatively, the alert device may include an audio unit to issue an audio warning as the second alert.

In some embodiments, the method 100 includes sending a second alert when the reductant level in the reductant tank is below the threshold. The method 100 may send a second alert even when the number of the fuel tank refill before the reductant in the reductant in the reductant tank has not reach the level below the second value.

In some embodiments, alternatively or additionally, the method 100 may send the second alert to a cluster in the instrument panel.

It should be appreciated that the method 100 may notify the reductant refill based on the number of the fuel tank refills before the reductant in the reductant tank is depleted only or based on the threshold level of the reductant in the reductant tank only or based on both the number of fuel tank refills before the reductant in the reductant tank is depleted and the threshold level of the reductant in the reductant tank.

Reductant in a reductant tank lasts a long driving distance than fuel in a fuel tank. By displaying the state of the reductant in the place adjacent to the fuel filler door, the user is informed of the requirement to refill the reductant tank in advance and in time. The user is further alerted when the reductant level drops to a specific level. Because of the similar events of refilling the tanks, it is intuitive for reminding the user of the need to refill the reductant when the user is refueling the fuel tank. Further, the notification is displayed at a manner that does not distract the driver while driving.

FIG. 4A is a schematic view of an example reductant refill indicator 200 according to one embodiment of the present disclosure. FIG. 4A shows a fuel filler cap 202 of a fuel tank and a reductant filler cap 204 of a reductant tank and a fuel filler door 206. The reductant refill indicator 200 is shown to be disposed on an inside of the fuel filler door 206. The reductant refill indicator 200 may be a LCD display communicated wireless or via wire with the reductant refill module. As described above, the reductant refill indicator 200 may display a state of the reductant in the reductant tank and issue an alert. For example, the reductant refill indicator 200 may display a message on a number of fuel tank refill before the reductant in the reductant tank is depleted. Alternatively or additionally, the reductant refill indicator 200 may display an amount of the reductant in the reductant tank and a message indicating an estimated distance a vehicle can run before the reductant is depleted. An alert or a warning sign may be shown on the LCD screen such as a flashing message in a red color or other types of display that attracts a user's attention. In some embodiments, the reductant refill indicator 200 may include an audio device to issue a voice message to alert a user the need to refill the reductant tank. In this way, the user is informed of the status of the reductant level in the reductant tank every time the user refuels the fuel tank.

FIG. 4B is a schematic view of another example reductant refill indicator 300 according to another embodiment of the present disclosure. The reductant refill indicator 300 is shown to be located on a vehicle panel adjacent to a fuel filler door or adjacent to a fuel filler cap 302 of a fuel tank and a reductant filler cap 304 of a reductant tank. The reductant refill indicator 300 includes a label 306 showing the number of fuel tank refills before the reductant in the reductant tank is depleted and a light source 308 that illuminates a specific color corresponding to the number of tank refill before the reductant in the reductant tank is depleted. In the depicted example, the light source 308 may be LEDs illuminating a green, yellow and red colors. The red LED illuminates when the number of the fuel tank refills before the reductant is depleted is one, and the red LED flashes when the number of the fuel tank refills before the reductant is depleted is less than one. The yellow LED illuminates when the number of the fuel tank refills before the reductant is depleted is 3. The green LED illuminates when the number of the fuel tank refills is 5 or greater.

FIG. 4C is a schematic view of another example reductant refill indicator 400 according to another embodiment of the present disclosure. The reductant refill indicator 400 is shown to be located on a vehicle panel adjacent to a fuel filler door or adjacent to a fuel filler cap 402 of a fuel tank and a reductant filler cap 404 of a reductant tank. The reductant refill indicator 400 includes a display screen such as a LCD screen. The number of the fuel tank refills before the reductant is depleted is shown in a plurality of bars. In the depicted example, the number of the fuel tank refills before the reductant is depleted is 3 and the three bars are shadowed or colored. When the number of the fuel tank refills before the reductant is depleted is one or less than one, a red bar or a red flash bar may be displayed on the reductant refill indicator.

FIG. 4D is a schematic view of another example reductant refill indicator 500 according to another embodiment of the present disclosure. The reductant refill indicator 500 is shown to be located on a vehicle panel adjacent to a fuel filler door or adjacent to a fuel filler cap 502 of a fuel tank and a reductant filler cap 504 of a reductant tank. The reductant refill indicator 500 includes a display 506 showing a single digit display of a number of fuel tank refills before the reductant in the reductant tank is depleted and a light source 508 that illuminates a specific color corresponding to the number of fuel tank refill before the reductant in the reductant tank is depleted. In the depicted example, the screen 506 indicates that the number of fuel tank refill before the reductant in the reductant tank is depleted is 4 and the light source 508 may illuminate a yellow or a green color. The reductant refill indicator 500 may further include an audio device 510 to issue a voice alert to reminder a user to refill the reductant tank.

The methods and systems to notify the reductant refill in a vehicle of the present disclosure are advantageous because a user is well informed of the need to refill the reductant tank because the status of the reductant level in the reductant tank is displayed to the user each time he or she refuels the fuel tank. This notification is particularly useful because some fuel stations do not provide the reductant and thus advanced planning is desired. As it is located adjacent to the fuel filler door, the reductant refill indicator notifies and alerts the user the reductant level at a proper place and timing without affecting other activities such as starting the vehicle and driving the vehicle.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the engine control system.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method to notify a user of a requirement to refill a reductant tank in a vehicle, comprising:
monitoring a reductant level in a reductant tank and a reductant consumption rate;
monitoring a fuel level in a fuel tank and a fuel consumption rate;
determining a state of the reductant in the reductant tank based on one of the reductant level, the reductant consumption rate, the fuel level and the fuel consumption rate; and
displaying the state of the reductant in the reductant tank on a reductant refill indicator located at a place adjacent to a fuel filler door.

2. The method of claim 1, wherein determining the state of reductant includes determining a number of fuel tank refills before a reductant in the reductant tank is depleted.

3. The method of claim 2, further comprising estimating an average fuel level remained in the fuel tank when a user refuels the fuel tank based on a fuel refueling profile of the user, and the number of fuel tank refills before the reductant in the reductant tank is depleted is further determined taking into account of the average fuel level remained in the fuel tank.

4. The method of claim 3, further comprising monitoring a vehicle load condition and maintaining a vehicle usage profile, wherein the number of fuel tank refills before the reductant in the reductant tank is depleted is determined by further incorporating a safe factor.

5. The method of claim 4, wherein a higher safe factor is used in determining the number of fuel tank refills before the reductant in the reductant tank is depleted when the vehicle is operated under a high load condition for a predetermined period.

6. The method of claim 2, wherein the reductant refill indicator includes a label showing the number of fuel tank refills before the reductant in the reductant tank is depleted and a light source that illuminates a specific color corresponding to the number of tank refill before the reductant in the reductant tank is depleted.

7. The method of claim 2, wherein the reductant refill indicator includes a plurality of LED including green, yellow and red LEDs, and the red LED illuminates when the reductant refill is required after one fuel tank refill, and the red LED flashes when the reductant refill is required after less than one fuel tank refill.

8. The method of claim 2, further comprising sending an alert when the number of fuel tank refill before the reductant in the reductant tank is depleted is less than a predetermined number, and wherein the reductant refill indicator is disposed on an interior of a fuel filler door or a vehicle body adjacent to a fuel filler cap and inside the fuel filler door.

9. A method to notify a user of a requirement to refill a reductant tank in a vehicle, comprising:
determining a number of fuel tank refills before a reductant in a reductant tank is depleted based on information of a reductant level in a reductant tank, a fuel level in a fuel tank, a reductant consumption rate and a fuel consumption rate; and
displaying information on a reductant refill indicator disposed on or adjacent to a fuel filler door to notify the number of fuel tank refill before the reductant is depleted.

10. The method of claim 9, wherein the reductant refill indicator includes at least one light source and a label, wherein illumination of the light source corresponds to a number of fuel tank refills before the reductant is depleted.

11. The method of claim 9, wherein the reductant level and the fuel level are real time values detected by a reductant level sensor and a fuel level sensor, and wherein the reductant consumption rate and the fuel consumption rate are real time values obtained from a power train control module or an engine control module of the vehicle.

12. The method of claim 9, wherein the reductant level and the fuel level are real time values determined by a reductant level sensor and a fuel level sensor, and wherein the reductant consumption rate and the fuel consumption rate are average values over a time period.

13. The method of claim 12, wherein a safe factor is used in determining the number of fuel tank refills before the reductant in the reductant tank is depleted and the safe factor is determined based on a vehicle load condition.

14. The method of claim 9, further comprising sending an alert to an alert device at the reductant refill indicator when the number of fuel refills is below a predetermined number.

15. A reductant refill notification system in a vehicle, comprising:
a reductant refill module to determine a state of reductant in a reductant tank; and
a reductant refill indicator provided on or adjacent to a fuel filler door and configured to display the state of reductant according to instructions from the reductant refill module.

16. The reductant refill notification system of claim 15, wherein the state of reductant in the reductant tank is a number of fuel tank refills before a reductant in the reductant tank is depleted.

17. The reductant refill notification system of claim 16, wherein the reductant refill module is configured to communicate with a powertrain control module via CAN bus to obtain information on one of a fuel level in a fuel tank, a fuel consumption rate, a reductant level in a reductant tank, and a reductant consumption rate, a fuel refill profile of a user, and a profile of historical reductant consumption, and to determine the number of fuel tank refills before the reductant is depleted.

18. The reductant refill notification system of claim 16, wherein the reductant refill indicator includes a label showing the number of fuel tank refills and a light source that illuminates a specific color corresponding to the number of tank refill.

19. The reductant refill notification system of claim 16, wherein the reductant refill indicator includes a digit display to present the number of the fuel tank refills before the reductant in the reductant tank is depleted and an alert device to issue an alert when the number of the fuel tank refills before the reductant in the reductant tank is depleted is less than a predetermined value.

20. The reductant refill notification system of claim 15, wherein the state of the reductant level in the reductant is an amount of the reductant in the reductant tank and wherein the alert device issues an alert when the amount of the reductant in the reductant tank is below a threshold.
